(19) United States
(12) Patent Application Publication
(10) Pub. No.: US 2022/0331778 A1
(43) Pub. Date: Oct. 20, 2022

(54) HYDROCARBON REFORMING CATALYST, HYDROCARBON REFORMING APPARATUS, AND METHOD FOR RECOVERING HYDROCARBON REFORMING CATALYST FROM DETERIORATION DUE TO SULFUR

(71) Applicant: Murata Manufacturing Co., Ltd., Nagaokakyo-shi (JP)

(72) Inventor: Hideto SATO, Nagaokakyo-shi (JP)

(21) Appl. No.: 17/849,885

(22) Filed: Jun. 27, 2022

Related U.S. Application Data
(63) Continuation of application No. PCT/JP2020/041148, filed on Nov. 4, 2020.

(30) Foreign Application Priority Data
Jan. 7, 2020 (JP) 2020-000922

(51) Int. Cl. B01J 23/00; B01J 23/90; C01B 3/26

(52) U.S. Cl. CPC B01J 23/002; B01J 23/90; C01B 3/26; B01J 2523/23; B01J 2523/48; B01J 2523/821

(57) ABSTRACT

A catalyst for forming a synthetic gas containing hydrogen and carbon monoxide from a hydrocarbon-based gas, the catalyst containing a complex oxide having a perovskite structure, wherein the complex oxide has a crystal phase containing CaZrO₃ as a primary component and contains Ru and at least one of Ce and Y.

### CROSS REFERENCE TO RELATED APPLICATIONS

The present application is a continuation of International application No. PCT/JP2020/041148, filed Nov. 4, 2020, which claims priority to Japanese Patent Application No. 2020-000922, filed Jan. 7, 2020, the entire contents of each of which are incorporated herein by reference.

### FIELD OF THE INVENTION

The present invention relates to a hydrocarbon reforming catalyst used for forming a synthetic gas containing hydrogen and carbon monoxide from a hydrocarbon-based gas, to a hydrocarbon reforming apparatus including the hydrocarbon reforming catalyst, and to a method for recovering the hydrocarbon reforming catalyst deteriorated due to sulfur.

### BACKGROUND OF THE INVENTION

In a known method, a synthetic gas containing hydrogen and carbon monoxide is obtained from a hydrocarbon-based gas by using a catalyst. Examples of the known catalyst used for a reforming reaction of the hydrocarbon-based gas include nickel-based catalysts in which nickel is supported by a base substrate such as alumina, ruthenium-based catalysts in which ruthenium is supported (refer to Patent Document 1), and rhodium-based catalysts in which rhodium is supported by a base substrate such as alumina (refer to Patent Document 2).

Further, in known catalysts, rhodium, cobalt, or nickel serving as an active component is supported by a carrier including lanthanum aluminate, strontium titanate, or barium titanate, which are perovskite-type compounds, to suppress carbon from depositing and to improve the activity at low temperature (refer to Patent Document 3).

As a common method for producing a metal-supporting catalyst, an impregnation method in which an active metal is dispersed on the carrier surface by dipping an oxide serving as a carrier into a solution of a metal salt or the like and, thereafter, performing heat treatment is known (Patent Document 1 to Patent Document 3).

In this regard, the carrier component is required to have high heat stability and strength and, therefore, is sufficiently sintered by being subjected to heat treatment at high temperature, while the dispersibility of the supported metal has to be maintained to obtain high activity. Consequently, to minimize aggregation during a heat treatment step, the supported metal is fixed to the carrier under a heat treatment condition at relatively low temperature by using a production step different from the synthesis of the carrier, as in the impregnation method.

The catalyst produced by the impregnation method can maintain high metal dispersibility. However, the impregnation step of supporting the metal component is necessary in addition to the carrier component synthesis step. Further, since the metal component is made to adhere by heat treatment at relatively low temperature, coupling between the metal and the carrier is weak, carbon deposition may cause an activity deterioration problem.

Consequently, as a method for producing a catalyst without using the impregnation step, a method in which a complex oxide containing BaNiY₂O₅ is synthesized through solid-phase synthesis so as to improve the dispersibility of a Ni component is proposed (Patent Document 4).

Patent Document 1: Japanese Unexamined Patent Application Publication No. 8-231204

Patent Document 2: Japanese Unexamined Patent Application Publication No. 9-168740

Patent Document 3: Japanese Unexamined Patent Application Publication No. 2006-346598

Patent Document 4: Japanese Unexamined Patent Application Publication No. 2015-136668

### SUMMARY OF THE INVENTION

The catalyst described in Patent Document 4 can suppress carbon from depositing. However, it cannot be said that the activity is sufficiently high, and there is room for improvement.

The present invention addresses the above-described problem, and it is an object to provide a hydrocarbon reforming catalyst having high activity, to provide a hydrocarbon reforming apparatus including such a hydrocarbon reforming catalyst, and to provide a method for recovering such a hydrocarbon reforming catalyst from deterioration due to sulfur.

A hydrocarbon reforming catalyst according to the present invention is a catalyst used for forming a synthetic gas containing hydrogen and carbon monoxide from a hydrocarbon-based gas and contains a complex oxide having a perovskite structure, wherein the complex oxide has a crystal phase containing CaZrO₃ as a primary component and contains Ru and at least one of Ce and Y.

According to the present invention, a hydrocarbon reforming catalyst having high activity, a hydrocarbon reforming apparatus including such a hydrocarbon reforming catalyst, and a method for recovering such a hydrocarbon reforming catalyst from deterioration due to sulfur can be provided.

### BRIEF DESCRIPTION OF THE DRAWINGS

FIG. 1 is a diagram illustrating the outline of the configuration of a hydrocarbon reforming apparatus.

FIG. 2 is a diagram illustrating X-ray diffraction patterns of the hydrocarbon reforming catalysts of examples 9 and 15 and comparative example 1.

### DETAILED DESCRIPTION OF THE PREFERRED EMBODIMENTS

An embodiment according to the present invention will be illustrated below so as to specifically describe the features of the present invention.

The hydrocarbon reforming catalyst according to the present invention is a catalyst used for forming a synthetic gas containing hydrogen and carbon monoxide from a hydrocarbon-based gas and satisfies the requirements, that is, containing a complex oxide having a perovskite structure, wherein the complex oxide has a crystal phase containing CaZrO₃ as a primary component and contains Ru.

For example, a propane gas containing propane as a primary component or a natural gas containing methane as a primary component may be used as the hydrocarbon-based gas that is a treatment object gas. In addition, hydrocarbon-based gases obtained by vaporizing liquid hydrocarbons, such as gasoline, kerosene, methanol, and ethanol, may also be used.

The reaction which forms a synthetic gas containing hydrogen and carbon monoxide from a hydrocarbon-based gas will be described with reference to steam reforming of a propane gas as an example. The steam reforming of a propane gas is represented by formula (1) below.

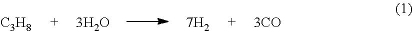

In this regard, the method for forming a synthetic gas containing hydrogen and carbon monoxide from a hydrocarbon-based gas is not limited to steam reforming. For example, oxygen, carbon dioxide, or a mixture thereof may be contained instead of steam. When carbon dioxide is contained, the reforming reaction is represented by formula (2) below.

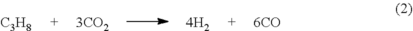

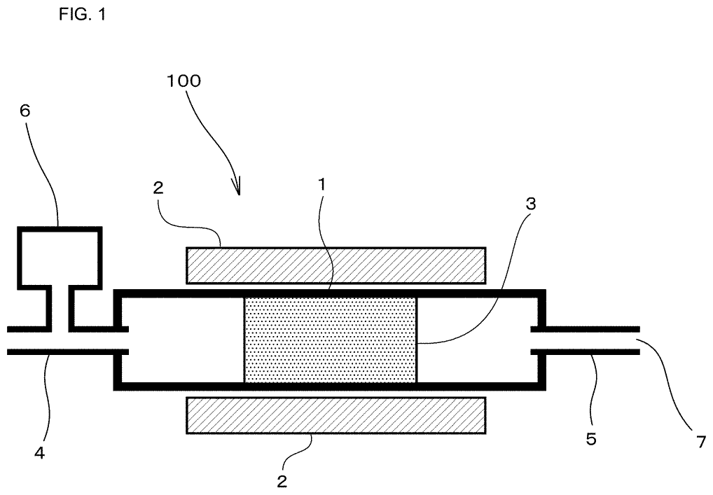

FIG. 1 is a diagram illustrating the outline of the configuration of a hydrocarbon reforming apparatus 100 to form a synthetic gas containing hydrogen and carbon monoxide from a treatment object gas containing at least a hydrocarbon. The hydrocarbon reforming apparatus 100 includes a pipe 1 through which the treatment object gas passes, a heating portion 2 to heat the treatment object gas passing through the pipe 1, and a hydrocarbon reforming catalyst 3 disposed at a position to contact the treatment object gas inside the pipe 1. The hydrocarbon reforming catalyst 3 is a catalyst that contains a complex oxide having a perovskite structure, and the complex oxide has a crystal phase containing CaZrO₃ as a primary component and containing Ru. In this regard, when just the treatment object gas is at sufficiently high temperature, the heating portion 2 may be skipped.

A gas feed pipe 4 is coupled to the upstream side of the pipe 1. A hydrocarbon is fed from a hydrocarbon supply source 6 to the gas feed pipe 4. However, the hydrocarbon supply source 6 may be disposed at the former stage of the gas feed pipe 4. In this regard, the hydrocarbon fed from the hydrocarbon supply source 6 may contain other components.

A gas discharge pipe 5 to discharge a synthetic gas containing hydrogen and carbon monoxide obtained through reforming is coupled to the downstream side of the pipe 1. The gas discharge pipe 5 is provided with a hydrogen outlet 7 and is configured to be capable of separating hydrogen contained in the synthetic gas. For example, a CO converter may be disposed in the gas discharge pipe 5 so as to remove carbon monoxide contained in the synthetic gas, and hydrogen may be separated through the hydrogen outlet 7.

### EXAMPLES 1 TO 8

Regarding the material for forming the hydrocarbon reforming catalyst, CaCO₃, ZrO₂, CeO₂, Y₂O₃, and RuO₂ were prepared and weighed so that the molar ratio of Ca:Zr:Ce:Y:Ru was set to be equal to the ratio described in Table 1, and pebbles, water, and a binder were wet-mixed so as to obtain a mixture. The resulting mixture was dried in an oven at a temperature of 120° C. and was pulverized and classified so as to have a granular shape with the size of about 2 mm. Thereafter, hydrocarbon reforming catalysts of examples 1 to 8 were obtained by firing the granular sample in air under the conditions of 1,000° C. and 1 hour.

As described in Table 1, the hydrocarbon reforming catalysts of examples 1 to 4 contained Ca, Zr, Ce, Y, and Ru. The molar ratios of Zr to Ca, the molar ratios of Ce to Ca, and the molar ratios of Y to Ca of the hydrocarbon reforming catalysts of examples 1 to 4 were equal to each other, but the molar ratios of Ru to Ca differed from each other. The molar ratios of Ru to Ca of the hydrocarbon reforming catalysts of examples 5 to 8 were equal to each other, but the molar ratios of Zr, Ce, and Y to Ca differed from each other.

### EXAMPLES 9 TO 11

Regarding the material for forming the hydrocarbon reforming catalyst, CaCO₃, ZrO₂, CeO₂, and RuO₂ were prepared and weighed so that the molar ratio of Ca:Zr:Ce:Ru was set to be equal to the ratio described in Table 1, and pebbles, water, and a binder were wet-mixed so as to obtain a mixture. Thereafter, hydrocarbon reforming catalysts of examples 9 to 11 were produced by using the same method as the method for producing the hydrocarbon reforming catalysts of examples 1 to 8.

As described in Table 1, the hydrocarbon reforming catalysts of examples 9 to 11 contained Ca, Zr, Ce, and Ru.

### EXAMPLES 12 TO 14

Regarding the material for forming the hydrocarbon reforming catalyst, CaCO₃, ZrO₂, Y₂O₃, and RuG₂ were prepared and weighed so that the molar ratio of Ca:Zr:Y:Ru was set to be equal to the ratio described in Table 1, and pebbles, water, and a binder were wet-mixed so as to obtain a mixture. Thereafter, hydrocarbon reforming catalysts of examples 12 to 14 were produced by using the same method as the method for producing the hydrocarbon reforming catalysts of examples 1 to 8.

As described in Table 1, the hydrocarbon reforming catalysts of examples 12 to 14 contained Ca, Zr, Y, and Ru.

### EXAMPLE 15

Regarding the material for forming the hydrocarbon reforming catalyst, CaCO₃, ZrO₂, and RuO₂ were prepared and weighed so that the molar ratio of Ca:Zr:Ru was set to be equal to the ratio described in Table 1, and pebbles, water, and a binder were wet-mixed so as to obtain a mixture. Thereafter, a hydrocarbon reforming catalyst of example 15 was produced by using the same method as the method for producing the hydrocarbon reforming catalysts of examples 1 to 8.

As described in Table 1, the hydrocarbon reforming catalyst of example 15 contained Ca, Zr, and Ru.

### COMPARATIVE EXAMPLE 1

Regarding the material for forming the hydrocarbon reforming catalyst, CaCO₃, CeO₂, and RuO₂ were prepared and weighed so that the molar ratio of Ca:Ce:Ru was set to be equal to the ratio described in Table 1, and pebbles, water, and a binder were wet-mixed so as to obtain a mixture. Thereafter, a hydrocarbon reforming catalyst of comparative example 1 was produced by using the same method as the method for producing the hydrocarbon reforming catalysts of examples 1 to 8.

The hydrocarbon reforming catalyst of comparative example 1 was a catalyst not satisfying the requirements of the present invention. As described in Table 1, the hydrocarbon reforming catalyst of comparative example 1 contained Ca, Ce, and Ru but contained neither Zr nor Y.

### COMPARATIVE EXAMPLE 2

Regarding the material for forming the hydrocarbon reforming catalyst, CaCO₃, ZrO₂, and RuO₂ were prepared and weighed so that the molar ratio of Ca:Zr:Ru was set to be equal to the ratio described in Table 1, and pebbles, water, and a binder were wet-mixed so as to obtain a mixture. The molar ratio of Ca:Zr:Ru in the resulting mixture was equal to the molar ratio of Ca:Zr:Ru of the materials used for producing the hydrocarbon reforming catalyst of example 15. Thereafter, a hydrocarbon reforming catalyst of comparative example 2 was produced by using the same method as the method for producing the hydrocarbon reforming catalyst of example 15 except that the firing temperature was set to be 600° C. The hydrocarbon reforming catalyst of comparative example 2 was a catalyst not satisfying the requirements of the present invention.

### COMPARATIVE EXAMPLE 3

Regarding the material for forming the hydrocarbon reforming catalyst, CaCO₃, ZrO₂, CeO₂, Y₂O₃, and RuO₂ were prepared and weighed so that the molar ratio of Ca:Zr:Ce:Y:Ru was set to be equal to the ratio described in Table 1, and pebbles, water, and a binder were wet-mixed so as to obtain a mixture. The molar ratio of Ca:Zr:Ce:Y:Ru in the resulting mixture was equal to the molar ratio of Ca:Zr:Ce:Y:Ru of the materials used for producing the hydrocarbon reforming catalyst of example 5. Thereafter, a hydrocarbon reforming catalyst of comparative example 3 was produced by using the same method as the method for producing the hydrocarbon reforming catalyst of example 5 except that the firing temperature was set to be 600° C. The hydrocarbon reforming catalyst of comparative example 3 was a catalyst not satisfying the requirements of the present invention.

<Examination of Crystal Phase>

The hydrocarbon reforming catalysts of examples 1 to 15 and comparative examples 1 to 3 above were pulverized by using a mortar, and the crystal phase was examined by powder XRD measurement. Regarding the powder XRD measurement, Cu-Kα1 was used as the X-ray.

Table 1 describes the crystal phase and the composition (molar ratio) examined with respect to the hydrocarbon reforming catalysts of examples 1 to 15 and comparative examples 1 to 3.

TABLE 1

| | | Molar ratio | | | | |
|---|---|---|---|---|---|---|
| Catalyst | Crystal phase | Ca | Zr | Ce | Y | Ru |
| Example 1 | CaZrO₃, CaO, CeO₂ | 1.00 | 0.60 | 0.30 | 0.10 | 0.01 |
| Example 2 | CaZrO₃, CaO, CeO₂ | 1.00 | 0.60 | 0.30 | 0.10 | 0.30 |
| Example 3 | CaZrO₃, CaO, CeO₂ | 1.00 | 0.60 | 0.30 | 0.10 | 0.14 |
| Example 4 | CaZrO₃, CaO, CeO₂ | 1.00 | 0.60 | 0.30 | 0.10 | 0.29 |
| Example 5 | CaZrO₃, CaO, CeO₂ | 1.00 | 0.60 | 0.30 | 0.10 | 0.06 |
| Example 6 | CaZrO₃, CaO, CeO₂, Y₂O₃ | 1.00 | 0.40 | 0.30 | 0.30 | 0.06 |
| Example 7 | CaZrO₃, CaO, CeO₂ | 1.00 | 0.40 | 0.50 | 0.10 | 0.06 |
| Example 8 | CaZrO₃, CaO, CeO₂, Y₂O₃ | 1.00 | 0.20 | 0.50 | 0.30 | 0.06 |
| Example 9 | CaZrO₃, CaO, CeO₂ | 1.00 | 0.70 | 0.30 | — | 0.06 |
| Example 10 | CaZrO₃, CaO, CeO₂ | 1.00 | 0.50 | 0.50 | — | 0.06 |
| Example 11 | CaZrO₃, CaO, CeO₂ | 1.00 | .020 | 0.80 | — | 0.07 |
| Example 12 | CaZrO₃ | 1.00 | 0.90 | — | 0.10 | 0.05 |
| Example 13 | CaZrO₃, CaO, Y₂O₃ | 1.00 | 0.70 | — | 0.30 | 0.05 |
| Example 14 | CaZrO₃, CaO, Y₂O₃ | 1.00 | 0.50 | — | 0.50 | 0.05 |
| Example 15 | CaZrO₃ | 1.00 | 1.00 | — | — | 0.05 |
| Comparative example 1 | CaO, CeO₂, RuO₂ | 1.00 | — | 1.00 | — | 0.07 |
| Comparative example 2 | CaCO₃, ZrO₂, RuO₂ | 1.00 | 1.00 | — | — | 0.05 |
| Comparative example 3 | CaCO₃, ZrO₂, CeO₂, Y₂O₃, RuO₂ | 1.00 | 0.60 | 0.30 | 0.10 | 0.06 |

Regarding the hydrocarbon reforming catalysts of examples 1 to 15, it was ascertained that a crystal phase of a complex oxide having a perovskite structure, specifically, a crystal phase containing CaZrO₃ as a primary component was present.

In addition, regarding hydrocarbon reforming catalysts of some examples, heterogeneous phases such as CaO, CeO₂, and Y₂O₃ were also observed in accordance with the composition ratio. However, even in these hydrocarbon reforming catalysts, the main crystal phase of the complex oxide having a perovskite structure was a crystal phase containing CaZrO₃ as a primary component.

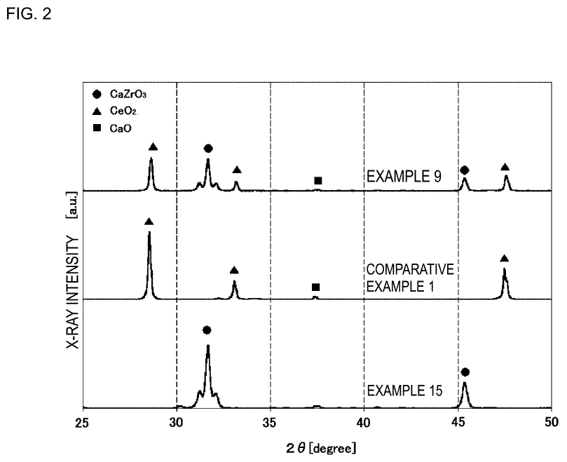

FIG. 2 illustrates X-ray diffraction patterns of the hydrocarbon reforming catalysts of examples 9 and 15 and comparative example 1. As illustrated in FIG. 2, it can be ascertained that a crystal phase attributed to CaZrO₃ is present in the hydrocarbon reforming catalysts of examples 9 and 15. In addition, it can be ascertained that diffraction lines attributed to CaO and CeO₂ are observed regarding the hydrocarbon reforming catalyst of example 9. On the other hand, no diffraction lines attributed to RuO₂ and Ru simple substance are observed regarding these hydrocarbon reforming catalysts.

That is, in the hydrocarbon reforming catalysts of examples 9 and 15, Ru is present in the structure of a crystal phase containing CaZrO₃ as a primary component. In other words, Ru is present as a component constituting a complex oxide having a perovskite structure.

Likewise, Ru is present as a component constituting a complex oxide having a perovskite structure in the hydrocarbon reforming catalysts of examples 10 and 11. Regarding the hydrocarbon reforming catalysts of examples 1 to 8 and 12 to 14 in which Y and Ru are contained in a complex oxide, each of Y and Ru is present as a component constituting the complex oxide having a perovskite structure.

On the other hand, it was ascertained that the hydrocarbon reforming catalyst of comparative example 2 was a mixture of CaCO₃, ZrO₂, and RuO₂ which were used for preparation since the firing temperature during production was 600° C. which was lower than the formation temperature of the complex oxide having a perovskite structure. Likewise, it was ascertained that the hydrocarbon reforming catalyst of comparative example 3 was also a mixture of CaCO₃, ZrO₂, CeO₂, Y₂O₃, and RuO₂ which were used for preparation.

<Examination of Composition>

Each of the hydrocarbon reforming catalysts of examples 1 to 15 and the hydrocarbon reforming catalysts of comparative examples 1 to 3 was finely pulverized by using a mortar, and the resulting powder was subjected to composition analysis by X-ray fluorescence analysis (XRF analysis). As a result, it was ascertained that regarding all the hydrocarbon reforming catalysts subjected to the composition analysis, the element molar ratio of the formulation for weighing was maintained and a change in the element molar ratio, such as reduction in each component due to heating and firing treatment, did not occur.

In this regard, in the hydrocarbon reforming catalysts of examples 1 to 15, the molar ratio of Ru to Ca was 0.01 to 0.29.

<Evaluation of Reforming>

The hydrocarbon reforming catalyst of each of examples 1 to 15 and comparative examples 1 to 3 was pulverized and classified into the size of 0.5 mm to 0.7 mm. Thereafter, a steam reforming evaluation test of a propane gas which is a hydrocarbon-based gas was performed by using the following method. However, the hydrocarbon-based gas is not limited to the propane gas.

The pipe 1 of the hydrocarbon reforming apparatus 100 illustrated in FIG. 1 was filled with 0.3 g of hydrocarbon reforming catalyst produced by using the above-described method, and heating at 600° C. was performed in the heating portion 2. Subsequently, a raw material gas was introduced from the gas feed pipe 4 at a flow rate of nitrogen (N₂) of 350 cc/min, propane (C₃H₈) of 7 cc/min, steam (H₂O) of 60 cc/min, and carbon dioxide (CO₂) of 60 cc/min.

The raw material gas introduced into the pipe 1 was reformed, and a synthetic gas containing hydrogen and carbon monoxide was discharged from the gas discharge pipe 5. The synthetic gas discharged from the gas discharge pipe 5 was introduced into a gas analyzer (gas chromatograph) after moisture was removed by a cooling-type trap, and a hydrogen concentration was measured.

Herein, as a result of calculation of the equilibrium gas composition at the above-described conditions of the gas partial pressure and the temperature, the hydrogen gas concentration percentage in an equilibrium state was 8.1% by volume except for moisture. Therefore, when the reaction of the introduced raw material gas progresses 100%, the concentration of hydrogen in an equilibrium state (hereafter referred to as an equilibrium hydrogen concentration) discharged from the gas discharge pipe 5 is 8.1% by volume.

(I) Examination of Initial Activity

It was assumed that no sulfur component was present for the first 1 hour from introduction of the raw material gas, and the hydrogen concentration after 1 hour (initial hydrogen concentration) was measured so as to examine the initial activity of the hydrocarbon reforming catalyst. Table 2 describes the concentration of hydrogen discharged from the gas discharge pipe 5 (initial hydrogen concentration) and the equilibrium achievement percentage of the initial activity when the hydrocarbon reforming catalyst of each of the examples and the comparative examples was used. The equilibrium achievement percentage of the initial activity was defined by formula (3) below.

equilibrium achievement percentage of initial activity=initial hydrogen concentration/equilibrium hydrogen concentration×100 (3)

(II) Examination of Characteristics After Deterioration Due to Sulfur

After the above-described initial activity was examined, a SO₂ gas was mixed so that the proportion was set to be 50 ppm relative to the total flow rate of the raw material gas of 477 cc/min, the hydrogen gas concentration after 1 hour was measured so as to examine deterioration in the catalyst activity in the presence of sulfur. As a result, regarding all the hydrocarbon reforming catalysts of examples 1 to 15 and comparative examples 1 to 3, the hydrogen concentration was 0 or a very low value.

(III) Examination of Characteristics After Heat Treatment

After the above-described characteristics after deterioration due to sulfur were examined, the hydrocarbon reforming catalyst was heated to 800° C. while a mixture gas not containing a hydrocarbon-based gas was, specifically a flow rate of 350 cc/min of nitrogen (N₂), 60 cc/min of steam (H₂O), and 60 cc/min of carbon dioxide (CO₂) were, introduced into the pipe 1, and heat treatment was successively performed for 1 hour at 800° C. Thereafter, the temperature was lowered to 600° C., and a flow rate of 350 cc/min of nitrogen (N₂), 7 cc/min of propane (C₃H₈), 60 cc/min of steam (H₂O) , and 60 cc/min of carbon dioxide (CO₂) were introduced again, and the hydrogen concentration after 1 hour was measured so as to examine the activity of the hydrocarbon reforming catalyst after heat treatment.

Table 2 describes the concentration of hydrogen discharged from the gas discharge pipe 5 and the equilibrium achievement percentage when the hydrocarbon reforming catalyst of each of the examples and the comparative examples was used. In Table 2, these are expressed as the hydrogen concentration “After heat treatment” and “Equilibrium achievement percentage after heat treatment”. The equilibrium achievement percentage after heat treatment was defined by formula (4) below.

equilibrium achievement percentage after heat treatment=hydrogen concentration after heat treatment/equilibrium hydrogen concentration×100 (4)

After the test was completed, to examine presence or absence of carbon deposition, the hydrocarbon reforming catalyst was cooled and removed in a N₂ atmosphere, and a change in the weight of the catalyst due to carbon combustion was examined by TG-DTA (thermogravimetric-differential thermal analysis). As a result, regarding all the hydrocarbon reforming catalysts of the examples and comparative examples subjected to the evaluation, carbon deposition was not observed.

TABLE 2

| | Hydrogen | | | |
|---|---|---|---|---|
| | concentration | | Equilibrium | Equilibrium |
| | (% by volume) | | achievement | achievement |
| | Initial | After heat | percentage of | percentage after |
| Catalyst | stage | treatment | initial activity | heat treatment |
| Example 1 | 4.2 | 3.8 | 52% | 47% |
| Example 2 | 6.5 | 6.5 | 80% | 80% |
| Example 3 | 8.0 | 8.1 | 99% | 100% |
| Example 4 | 8.1 | 8.1 | 100% | 100% |
| Example 5 | 7.3 | 7.0 | 90% | 87% |
| Example 6 | 7.4 | 7.7 | 91% | 95% |
| Example 7 | 7.8 | 7.8 | 96% | 96% |
| Example 8 | 8.0 | 2.6 | 99% | 32% |
| Example 9 | 7.9 | 6.9 | 97% | 85% |
| Example 10 | 7.6 | 7.0 | 94% | 86% |
| Example 11 | 4.7 | 2.5 | 58% | 31% |
| Example 12 | 7.1 | 6.5 | 88% | 80% |
| Example 13 | 7.3 | 7.2 | 90% | 89% |
| Example 14 | 6.8 | 5.0 | 84% | 62% |
| Example 15 | 2.8 | 5.9 | 34% | 73% |
| Comparative | 0.5 | 1.8 | 6% | 22% |
| example 1 | | | | |
| Comparative | 1.5 | 3.0 | 19% | 37% |
| example 2 | | | | |
| Comparative | 1.0 | 2.0 | 12% | 25% |
| example 3 | | | | |

<Initial Activity>

As described in Table 2, when the hydrocarbon reforming catalysts of examples 1 to 15 satisfying the requirements of the present invention were used, the equilibrium achievement percentage of the initial activity was 34% or more. On the other hand, when the hydrocarbon reforming catalysts of comparative examples 1 to 3 not satisfying the requirements of the present invention were used, the equilibrium achievement percentage of the initial activity was 19% or less and was a low value.

The reason for the hydrocarbon reforming catalyst satisfying the requirements of the present invention having high initial activity is as described below. That is, it is conjectured that the hydrocarbon reforming catalyst is stabilized by the Ru component in a solid solution state being dispersed in the complex oxide having a crystal phase containing CaZrO₃ as a primary component and having a perovskite structure, aggregation and vaporization of the Ru component under a high-temperature oxidizing condition can be suppressed from occurring, and, as a result, the activity is improved.

In this regard, when the hydrocarbon reforming catalysts of examples 1 to 14, in which the complex oxide further contained at least one of Ce and Y, were used, the equilibrium achievement percentage of the initial activity was 52% or more and was a high value. Therefore, regarding the hydrocarbon reforming catalyst, it is favorable that the complex oxide further contain at least one of Ce and Y.

In addition, when the hydrocarbon reforming catalysts of examples 2 to 8, in which the complex oxide further contained Ce and Y and in which the molar ratio of Ru to Ca of 0.03 to 0.29, were used, the equilibrium achievement percentage of the initial activity was 80% or more and was a high value. Therefore, regarding the hydrocarbon reforming catalyst, it is favorable that the complex oxide further contain Ce and Y and that the molar ratio of Ru to Ca be 0.03 to 0.29.

In addition, when the hydrocarbon reforming catalysts of examples 9 to 11, in which the complex oxide further contained Ce but did not contain Y, were used, the equilibrium achievement percentage of the initial activity was 58% or more and was a high value. Therefore, it is favorable that the complex oxide further contain Ce but not contain Y.

In addition, when the hydrocarbon reforming catalysts of examples 12 to 14, in which the complex oxide further contained Y but did not contain Ce, were used, the equilibrium achievement percentage of the initial activity was 84% or more and was a high value. Therefore, it is favorable that the complex oxide further contain Y but not contain Ce.

<Recovery from Deterioration Due to Sulfur by Heating>

As described above, when a sulfur component is contained in the raw material gas, the catalyst activity is deteriorated. However, as described in Table 2, the equilibrium achievement percentage after heat treatment was 31% or more. That is, it was found that even when the catalyst activity was deteriorated due to sulfur, the catalyst activity was recovered by heat treatment. Therefore, even when the hydrocarbon reforming catalyst of the present invention is used in an environment in which sulfur is present, continuous usage is possible by performing periodical heat treatment.

In this regard, although the specific reasons for the catalytic function deteriorated due to sulfur being recovered by heat treatment are not certain, it is conjectured that Ru in a solid solution state being dispersed in the complex oxide having a crystal phase containing CaZrO₃ as a primary component facilitates elimination of a sulfur component since the chemical state differs from that of just Ru or RuO₂. In addition, it is conjectured that Ru being present in the complex oxide enables high dispersion state to be maintained without aggregation and enables the catalyst activity to be maintained even when heating to 800° C. is performed.

In this regard, since the recovery state after heat treatment differs in accordance with the amount of Y or Ce added, it is predicted that a certain amount of Y or Ce in a solid solution state being present in the CaZrO₃ structure also exerts an effect on the chemical state of Ru.

Herein, in the description above, the catalyst activity is recovered from deterioration due to sulfur by heating the hydrocarbon reforming catalyst at 800° C. for 1 hour while a hydrocarbon gas is not present. However, the condition of 800° C. and 1 hour is just an example, and the catalyst activity can be recovered by heating at a temperature of 700° C. or higher for a predetermined time (for example, 5 min or more).

The present invention is not limited to the above-described embodiment and can be variously applied and modified within the scope of the present invention.

For example, the hydrocarbon reforming catalysts of the above-described examples take on granular forms. However, similarly to the common metal-supporting catalyst, a hydrocarbon reforming catalyst made into a powder may be supported by a ceramic or metal base material and be used. Alternatively, a catalyst powder may be formed by a method of press molding, extrusion molding, or the like without using a base material and be used in the form of a pellet, a ring, a honeycomb, or the like.

### REFERENCE SIGNS LIST

1: pipe

2: heating portion

3: hydrocarbon reforming catalyst

4: gas feed pipe

5: gas discharge pipe

6: hydrocarbon supply source

7: hydrogen outlet

100: hydrocarbon reforming apparatus

1. A hydrocarbon reforming catalyst comprising:
a complex oxide having a perovskite structure,
wherein the complex oxide has a crystal phase containing CaZrO₃ as a primary component and contains Ru and at least one of Ce and Y.

2. The hydrocarbon reforming catalyst according to claim 1, wherein a molar ratio of Ru to Ca is 0.01 to 0.29.

3. The hydrocarbon reforming catalyst according to claim 1, wherein the complex oxide contains Y.

4. The hydrocarbon reforming catalyst according to claim 3, wherein the complex oxide contains Ce.

5. The hydrocarbon reforming catalyst according to claim 4, wherein the molar ratio of Ru to Ca is 0.03 to 0.29.

6. The hydrocarbon reforming catalyst according to claim 3, wherein the complex oxide does not contain Ce.

7. The hydrocarbon reforming catalyst according to claim 1, wherein the complex oxide contains Ce but does not contain Y.

8. A hydrocarbon reforming apparatus comprising:
a pipe through which a treatment object gas containing at least a hydrocarbon passes; and
the hydrocarbon reforming catalyst according to claim 1 disposed at a position to contact the treatment object gas inside the pipe.

9. The hydrocarbon reforming apparatus according to claim 8, wherein a molar ratio of Ru to Ca is 0.01 to 0.29 in the hydrocarbon reforming catalyst.

10. The hydrocarbon reforming apparatus according to claim 8, wherein the complex oxide of the hydrocarbon reforming catalyst contains Y.

11. The hydrocarbon reforming apparatus according to claim 10, wherein the complex oxide of the hydrocarbon reforming catalyst contains Ce.

12. The hydrocarbon reforming apparatus according to claim 11, wherein the molar ratio of Ru to Ca is 0.03 to 0.29 in the hydrocarbon reforming catalyst.

13. The hydrocarbon reforming apparatus according to claim 10, wherein the complex oxide of the hydrocarbon reforming catalyst does not contain Ce.

14. The hydrocarbon reforming apparatus according to claim 8, wherein the complex oxide of the hydrocarbon reforming catalyst contains Ce but does not contain Y.

15. A method for recovering a hydrocarbon reforming catalyst from deterioration due to sulfur, the method comprising:
heating the hydrocarbon reforming catalyst according to claim 1 at a temperature of 700° C. or higher for a predetermined time while a hydrocarbon-based gas is not present.

16. The method according to claim 15, wherein a molar ratio of Ru to Ca is 0.01 to 0.29 in the hydrocarbon reforming catalyst.

17. The method according to claim 15, wherein the complex oxide of the hydrocarbon reforming catalyst contains Y.

18. The method according to claim 17, wherein the complex oxide of the hydrocarbon reforming catalyst contains Ce.

19. The method according to claim 18, wherein the molar ratio of Ru to Ca is 0.03 to 0.29 in the hydrocarbon reforming catalyst.

20. The method according to claim 15, wherein the complex oxide of the hydrocarbon reforming catalyst contains Ce but does not contain Y.
